(19) United States
(12) Patent Application Publication
(10) Pub. No.: US 2023/0180864 A1
(43) Pub. Date: Jun. 15, 2023

(54) Antimicrobial Face Mask

(71) Applicant: Kraton Polymers LLC, Houston, TX (US)

(72) Inventors: Vijay Mhetar, Houston, TX (US); Richard Blackwell, Houston, TX (US); Roger Tocchetto, Houston, TX (US); Sharman McGilbert, Houston, TX (US); Bert Krutzer, Amsterdam (NL)

(73) Assignee: Kraton Polymers LLC, Houston, TX (US)

(21) Appl. No.: 17/995,758

(22) PCT Filed: Apr. 19, 2021
(86) PCT No.: PCT/US2021/070410

§ 371 Date: Oct. 10, 2022

Related U.S. Application Data
(60) Provisional application No. 63/011,576, filed on Apr. 17, 2020.
(60) Provisional application No. 63/019,634, filed on May 4, 2020.
(60) Provisional application No. 63/145,976, filed on Feb. 4, 2021.

(51) Int. Cl. A41D 13/11

(52) U.S. Cl. CPC A41D 13/1192; A41D 13/1161

(57) ABSTRACT

A face mask is disclosed. The face mask includes a mask pad adapted to cover a nose and a mouth of a wearer and allows a passage of air therethrough to the wearer and restricts a passage of microbes. The mask pad has at least a surface protected by a sulfonated polymeric layer for killing at least 90% microbes within 120 minutes of contact with at least a surface of the face mask. The sulfonated polymeric layer consists essentially of a sulfonated polymer, the sulfonated polymer being selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof.

### TECHNICAL FIELD

The disclosure relates to a face mask. More particularly, the disclosure relates to a face mask having a protective layer of sulfonated polymer.

### BACKGROUND

With the spread of contagious diseases, such as, COVID 19, it becomes necessary to protect people and prevent the people from coming into contact with diseases spreading microbes, viruses, bacteria, etc. Face masks having at least 2 layers of fabric are recommended to reduce the spread of COVD-19. However, the microbes may accumulate on the face mask and remain active for relatively long duration. The microbes may subsequently contact the hands of the wearer, and may find their way inside the human body, which is undesirable.

There are a variety of face masks that are commercially available. As used herein, the terms “mask” and “facemask” are used interchangeably and include, without limitation, face masks, respirators, face shields, surgical masks, filter masks, mouth masks, and gas masks. These facemasks serve various functions which include providing protection from splashes, and / or filtering air-borne contaminants, including pathogens. Facemasks differ substantially in their filtering capacity and their comfort level. For example, respirators protect from exposure to airborne particles, and designed to seal tight to the face of the wearer. Surgical masks and homemade masks from fabric provide a barrier to splashes, droplets, and spit, and do not necessarily seal tight to the face of the wearer. Some masks are disposable, e.g., surgical masks. Some are reusable in the case of respirators, the filter can be replaced, or with homemade masks with washable fabric.

It is desirable to have face masks readily kills microbes upon contact with the face mask surface, prior to being inhaled by the wearer. Further, it is desirable to have a face mask such that the environment, such as other persons surrounding the face mask wearer, are protected from particles and microbes that are exhaled by the wearer of the face mask.

### SUMMARY

In a first aspect, a face mask is disclosed. The face mask includes a mask body configured to cover at least a wearer’s mouth and nose. The mask body allows passage of air from ambient through to the wearer. The mask body has a first surface facing the face of the wearer and a second surface disposed opposite to the first surface and exposed to the ambient. The face mask further comprises an engagement structure configured to attach the mask body to the wearer’s head. At least one of the first surface and the second surface is protected by a sulfonated polymeric layer for killing at least 95% microbes within 30 minutes of contact with the first surface. The sulfonated polymeric layer consists essentially of a sulfonated polymer, the sulfonated polymer is selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof. The sulfonated polymer has a degree of sulfonation of at least 10%. The sulfonated polymeric layer has a thickness of at least > 1 µm.

In some aspects, the sulfonated polymeric layer comprises at least 50 wt.%, more preferably at least 70 wt.%, even more preferably at least 90 wt.%, yet more preferably at least 95 wt.%, still more preferably at least 98 wt.%, even more preferably at least 99 wt.% and most preferably 100 wt.% (i.e. consists) of one or more of the sulfonated polymers.

In embodiments, the mask body has a Bacteria Filtration Efficiency (BFE) of > 60%.

In some embodiments, the mask pad includes a filter for filtering an air passing therethrough. The filter is coated with the sulfonated polymer.

### BRIEF DESCRIPTION OF THE DRAWINGS

FIG. 1 is a perspective view of an embodiment of a face mask.

FIG. 2 is a front view of an embodiment of a face mask having various layers.

FIG. 3 is a front view of an embodiment of a face mask having a removable filter

FIG. 4 is perspective view of an embodiment of a mask having a removable filter.

FIG. 5 is a perspective view of an embodiment of a face mask.

FIG. 6 is a perspective view of an embodiment of a face mask with a valve.

FIG. 7 is a front view of an embodiment of a face mask.

### DETAILED DESCRIPTION

The following terms used the specification have the following meanings:

“Effective amount” refers to an amount sufficient to alter, destroy, inactivate, and / or neutralize microbes, e.g., an amount sufficient to sterilize and kill microbes in contact with outer surface of the face panel in a face shield.

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which the weight of the polymer required to provide 1 mole of exchangeable protons.

“Microbes” refers to microorganisms including bacteria, archaea, fungi (yeasts and molds), algae, protozoa, and viruses, with microscopic size.

“Surface pH” refers to the pH on the contact surface of the bio-secure material, that results from surface bound moieties e.g., the coating layer. The surface pH can be measured with commercial surface pH measuring instruments, e.g., SenTix™Sur-electrode from WTW Scientific-Technical Institute GmbH, Weilheim, Germany.

“Filter” herein refers to an air permeable substrate, and depending on the face mass or respirator type, in embodiments, the substrate demonstrate a Bacteria Filtration Efficiency (BFE) of at least 60%, preferably at least 70%, more preferably at least 80%, and most preferably at least 90% (as with surgical masks). N95 respirators have a >99% PFE, and a particle filtration efficient (PFE) of > 95%.

The disclosure relates to a face mask having a filter body having a protective antimicrobial layer that kills microbes within a predefined duration of contact. The filter body is coated with, protected with, or constructed to have a layer comprising a self-sterilizing (self-disinfecting) sulfonated polymeric material. The sulfonated polymer is employed for killing at least 95% microbes within a pre-defined duration of contact with the sulfonated polymeric coating. The face mask includes an attachment structure to secure the face mask in front of the face of the wearer. In embodiments, the self-sterilizing sulfonated polymeric layer comprises, consists essentially of, or consists of a sulfonated polymer.

Self-sterilizing Material - Sulfonated Polymer: Sulfonated polymer refers to polymers having a sulfonate group, e.g., —SO₃, either in the acid form (e.g., —SO₃H, sulfonic acid) or a salt form (e.g.,—SO₃Na). The term “sulfonated polymer” also covers sulfonate containing polymers, e.g., polystyrene sulfonate.

The sulfonated polymer is selected from the group of perfluorosulfonic acid polymers (e.g., sulfonated tetrafluoroethylene), sulfonated polyolefins, sulfonated polyimides, sulfonated polyamides, sulfonated polyester, polystyrene sulfonates, sulfonated block copolymers, sulfonated polyolefins, sulfonated polysulfones such as polyether sulfone, sulfonated polyketones such as polyether ether ketone, sulfonated polyphenylene ethers, and mixtures thereof.

The sulfonated polymer is characterized as being sufficiently or selectively sulfonated to contain from 10 - 100 mol % sulfonic acid or sulfonate salt functional groups based on the number of monomer units or the block to be sulfonated (“degree of sulfonation”), to kill at least 95% of microbes within 120 minutes of coming into contact with the coating material. In embodiments, the sulfonated polymer has a degree of sulfonation of > 25 mol %, or > 50 mol %, or < 95 mol %, or 25-70 mol %. Degree of sulfonation can be calculated by NMR or ion exchange capacity (IEC).

In embodiments, the sulfonated polymer is a sulfonated tetrafluoroethylene, having a polytetrafluoroethylene (PTFE) backbone; (2) side chains of vinyl ethers (e.g., — O — CF₂ — CF — O — CF₂ — CF₂—) which terminate in sulfonic acid groups in a cluster region.

In embodiments, the sulfonated polymer is a polystyrene sulfonate, examples include potassium polystyrene sulfonate, sodium polystyrene sulfonate, a co-polymer of sodium polystyrene sulfonate and potassium polystyrene sulfonate (e.g., a polystyrene sulfonate copolymer), having a molecular weight of 20,000 to 1,000,000 Daltons, or > 25,000 Daltons, or > 40,000 Dalton, or > 50,000, or > 75,000, or > 100,000 Daltons, or > 400,000 Daltons, or < 200,000, or < 800,000 Daltons, or up to 1,500,000 Daltons. The polystyrene sulfonate polymers can either be crosslinked or uncrosslinked. In embodiments, the polystyrene sulfonate polymers are uncrosslinked and water soluble.

In embodiments, the sulfonated polymer is a polysulfone, selected from the group of aromatic polysulfones, polyphenylenesulfones, aromatic polyether sulfones, dichlorodiphenoxy sulfones, sulfonated substituted polysulfone polymers, and mixtures thereof. In embodiments, the sulfonated polymer is a sulfonated polyethersulfone copolymer, which can be made with reactants including sulfonate salts such as hydroquinone 2-potassium sulfonate (HPS) with other monomers, e.g., bisphenol A and 4-fluorophenyl sulfone. The degree of sulfonation in the polymer can be controlled with the amount of HPS unit in the polymer backbone.

In embodiments, the sulfonated polymer is a sulfonated polyether ketone. In embodiments, the sulfonated polymer is a sulfonated polyether ketone ketone (SPEKK), obtained by sulfonating a polyether ketone ketone (PEKK). The polyether ketone ketone can be manufactured using diphenyl ether and a benzene dicarbonic acid derivative. The sulfonated PEKK can be available as an alcohol and / or water-soluble product, e.g., for subsequent use to coat the face mask or in spray applications.

In embodiments, the sulfonated polymer is a sulfonated poly(arylene ether) copolymer containing pendant sulfonic acid groups. In embodiments, the sulfonated polymer is a sulfonated poly(2,6-dimethyl-1,4-phenylene oxide), commonly referred to as sulfonated polyphenylene oxide. In embodiments, the sulfonated polymer is a sulfonated poly(4-phenoxybenzoyl-1,4-phenylene) (S-PPBP). In embodiments, the sulfonated polymer is a sulfonated polyphenylene having 2 to 6 pendant sulfonic acid groups per polymer repeat, and characterized as having 0.5 meq (SO3H)/g of polymer to 5.0 meq (SO3H)/g polymer, or at least 6 meq/g (SO3H)/g polymer.

In embodiments, the sulfonated polymer is a sulfonated polyamide, e.g. aliphatic polyamides such nylon-6 and nylon-6,6, partially aromatic polyamides and polyarylamides such as poly(phenyldiamidoterephthalate), provided with sulfonate groups chemically bonded as amine pendant groups to nitrogen atoms in the polymer backbone. The sulfonated polyamide can have a sulfonation level of 20 to up to 100% of the amide group, with the sulfonation throughout the bulk of the polyamide. In embodiments, the sulfonation is limited to a high density of sulfonate groups at the surface, e.g., > 10%, > 20%, > 30%, or > 40%, or up to 100% of the sulfonated amide group at the surface (within 50 nm of the surface).

In embodiments, the sulfonated polymer is a sulfonated polyolefin, containing at least 0.1 meq, or > 2 meq, or > 3 meq, or > 5 meq, or 0.1 to 6 meq of sulfonic acid per gram of polyolefin. In embodiments, the sulfonated polymer is a sulfonated polyethylene. The sulfonated polyolefin can be formed by chlorosulfonation of a solid polyolefin obtained by polymerization of an olefin or a mixture of olefins selected from a group consisting of ethylene, propylene, butene-1,4-methylpentene-1, isobutylene, and styrene. The sulfonyl chloride groups can then be hydrolyzed, for example, in an aqueous base such as potassium hydroxide or in a water dimethylsulfoxide (DMF) mixture to form sulfonic acid groups. In embodiment, the sulfonated polyolefin is formed by submerging or passing polyolefin object in any form of powder, fiber, yarn, woven fabric, a film, a preform, etc., through a liquid containing sulfur trioxide (SO₃), a sulfur trioxide precursor (e.g., chlorosulfonic acid, HSO₃Cl), sulfur dioxide (SO₂), or a mixture thereof. In other embodiments, the polyolefin object is brought into contact with a sulfonating gas, e.g., SO₂ or SO₃, or gaseous reactive precursor, or a sulfonation additive that evolves a gas SOₓ at elevated temperature.

The polyolefin precursor to be sulfonated can be, for example, a poly-α-olefin, such as polyethylene, polypropylene, polybutylene, polyisobutylene, ethylene propylene rubber, or a chlorinated polyolefin (e.g., polyvinylchloride, or PVC), or a polydiene, such as polybutadiene (e.g., poly-1,3-butadiene or poly-1,2-butadiene), polyisoprene, dicyclopentadiene, ethylidene norbornene, or vinyl norbornene, or a homogeneous or heterogeneous composite thereof, or a copolymer thereof (e.g., EPDM rubber, i.e., ethylene propylene diene monomer). In embodiments, the polyolefin is selected from low density polyethylene (LDPE), linear low density polyethylene (LLDPE), very low density polyethylene (VLDPE), high density polyethylene (HDPE), medium density polyethylene (MDPE), high molecular weight polyethylene (HMWPE), and ultra-high molecular weight polyethylene (UHMWPE).

In embodiments, the sulfonated polymer is a sulfonated polyimide, e.g., aromatic polyimides in both thermoplastic and thermosetting forms, having excellent chemical stability and high modulus properties. Sulfonated polyimide can be prepared by condensation polymerization of dianhydrides with diamines, wherein one of the monomeric units contains sulfonic acid, sulfonic acid salt, or sulfonic ester group. The polymer can also be prepared by direct sulfonation of aromatic polyimide precursors, using sulfonation agents such as chlorosulfonic acid, sulfur trioxide and sulfur trioxide complexes. In embodiments, the concentration of sulfonic acid groups in the sulfonated polyimide as measured by ion exchange capacity, IEC, varying from 0.1 meq/g to above 3 meq/g, or at least 6 meq/g.

In embodiments, the sulfonated polymer is a sulfonated polyester, formed by directly sulfonating a polyester resin in any form, e.g., fiber, yarn, woven fabric, film, sheet, and the like, with a sulfuric anhydride-containing gas containing sulfuric anhydride, for a concentration of the sulfone group on the surface of the polyester ranging from 0.1 meq/g to above 3 meq/g, e.g., up to 5 meq/g, or at least 6 meq/g.

In embodiments, the sulfonated polymer is a selectively sulfonated negative-charged anionic block copolymer. The term “selectively sulfonated” definition to include sulfonic acid as well as neutralized sulfonate derivatives. The sulfonate group can be in the form of metal salt, ammonium salt or amine salt.

Depending on the applications and the desired properties, the sulfonated polymer can be modified (or funcationalized). In embodiments, the sulfonated polymer is neutralized with any of various metal counterions, including alkali, alkaline earth, and transition metals, with at least 10% of the sulfonic acid groups being neutralized. In embodiments, the sulfonated polymer is neutralized with inorganic or organic cationic salts, e.g, those based on ammonium, phosphonium, pyridinium, sulfonium and the like. Salts can be monomeric, oligomeric, or polymeric. In embodiments, the sulfonated polymer is neutralized with various primary, secondary, or tertiary amine-containing molecules, with > 10% of the sulfonic acid or sulfonate functional groups being neutralized.

In embodiments, the sulfonic acid or sulfonate functional group is modified by reaction with an effective amount of polyoxyalkyleneamine having molecular weights from 140 to 10,000. Amine-containing neutralizing agents can be mono-functional or multi-functional; monomeric, oligomeric, or polymeric. In alternative embodiments, the sulfonated polymer is modified with alternative anionic functionalities, such as phosphonic acid or acrylic and alkyl acrylic acids.

In embodiments, amine containing polymers are used for the modification of the sulfonated polymers, forming members of a class of materials termed coaservates. In examples, the neutralizing agent is a polymeric amine, e.g., polymers containing benzylamine functionality. Examples include homopolymers and copolymers of 4-dimethylaminostyrene which has been described in U.S. Pat. 9,849,450, incorporated herein by reference. In embodiments, the neutralizing agents are selected from polymers containing vinylbenzylamine functionality, e.g., polymers synthesized from poly-p-methylstyrene containing block copolymers via a bromination-amination strategy, or by direct anionic polymerization of amine containing styrenic monomers. Examples of amine functionalities for functionalization include but are not limited to p - vinylbenzyldimethylamine (BDMA ), p - vinylbenzylpyrrolidine (VBPyr), p - vinylbenzyl-bis(2-methoxyethyl)amine (VBDEM), p-vinylbenzylpiperazine (VBMPip), and p-vinylbenzyldiphenylamine (VBDPA). In embodiments, corresponding phosphorus containing polymers can also be used for the functionalization of the sulfonated polymers.

In embodiments, the monomer or the block containing amine functionality or phosphine functionality can be neutralized with acids or proton donors, creating quaternary ammonium or phosphonium salts. In other embodiments, the sulfonated polymer containing tertiary amine is reacted with alkylhalides to form functional groups, e.g., quaternized salts. In some embodiments, the sulfonated polymer can contain both cationic and anionic functionality to form so-called zwitterionic polymers.

In some embodiments, the sulfonated polymer is a selectively sulfonated negative-charged anionic block copolymer, which “selectively sulfonated” definition to include sulfonic acid as well as neutralized sulfonate derivatives. The sulfonate group can be in the form of metal salt, ammonium salt or amine salt. In embodiments, the sulfonated block polymer has a general configuration A-B-A,(A-B)ₙ(A), (A-B-A)ₙ, (A-B-A)ₙX, (A-B)ₙX,A-D-B, A-B-D, A-D-B-D-A, A-B-D-B-A, (A-D-B)ₙA, (A-B-D)ₙA (A-D-B)ₙX, (A-B-D)ₙX or mixtures thereof; where n is an integer from 0 to 30, or 2 to 20 in embodiments; and X is a coupling agent residue. Each A and D block is a polymer block resistant to sulfonation. Each B block is susceptible to sulfonation. For configurations with multiple A, B or D blocks, the plurality of A blocks, B blocks, or D blocks can be the same or different.

In embodiments, the A blocks are one or more segments selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. If the A segments are polymers of 1,3-cyclodiene or conjugated dienes, the segments will be hydrogenated subsequent to polymerization of the block copolymer and before sulfonation of the block copolymer. The A blocks may also contain up to 15 mol % of the vinyl aromatic monomers such as those present in the B blocks.

In embodiments, the A block is selected from para-substituted styrene monomers selected from para-methylstyrene, para-ethyl styrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene and mixtures of the above monomers. Examples of para-substituted styrene monomers include para-t-butylstyrene and para-methylstyrene, with para-t-butylstyrene being most preferred. Monomers may be mixtures of monomers, depending on the particular source. In embodiments, the overall purity of the para-substituted styrene monomers be at least 90%-wt., or > 95%-wt., or > 98%-wt. of the para-substituted styrene monomer.

In embodiments, the block B comprises segments of one or more polymerized vinyl aromatic monomers selected from unsubstituted styrene monomer, ortho-substituted styrene monomers, meta-substituted styrene monomers, alpha-methylstyrene monomer, 1,1-diphenylethylene monomer, 1,2-diphenylethylene monomer, and mixtures thereof. In addition to the monomers and polymers noted, in embodiments the B blocks also comprises a hydrogenated copolymer of such monomer (s) with a conjugated diene selected from 1,3-butadiene, isoprene and mixtures thereof, having a vinyl content of between 20 and 80 mol percent. These copolymers with hydrogenated dienes can be any of random copolymers, tapered copolymers, block copolymers or controlled distribution copolymers. The block B is selectively sulfonated, containing from about 10 to about 100 mol % sulfonic acid or sulfonate salt functional groups based on the number of monomer units. In embodiments, the degree of sulfonation in the B block ranges from 10 to 95 mol%, or 15 - 80 mol%, or 20 - 70 mol%, or 25 - 60 mol%, or > 20 mol%, or > 50 mol%.

The D block comprises a hydrogenated polymer or copolymer of a conjugated diene selected from isoprene, 1,3-butadiene and mixtures thereof. In other examples, the D block is any of an acrylate, a silicone polymer, or a polymer of isobutylene with a number average molecular weight of > 1000, or >2000, or >4000, or >6000.

The coupling agent X is selected from coupling agents known in the art, including polyalkenyl coupling agents, dihaloalkanes, silicon halides, siloxanes, multifunctional epoxides, silica compounds, esters of monohydric alcohols with carboxylic acids, (e.g. methylbenzoate and dimethyl adipate) and epoxidized oils.

The antimicrobial and mechanical properties of the sulfonated block copolymer can be varied and controlled by varying the amount of sulfonation, the degree of neutralization of the sulfonic acid groups to the sulfonated salts, as well as controlling the location of the sulfonated group(s) in the polymer. In embodiments and depending on the applications, e.g., one with the need for water dispersity / solubility, or at the other spectrum, one with the need for sufficient durability with constant wiping with water based cleaners, the sulfonated block copolymer can be selectively sulfonated for desired water dispersity properties or mechanical properties, e.g., having the sulfonic acid functional groups attached to the inner blocks or middle blocks, or in the outer blocks of a sulfonated block copolymer, as in US Patent No. US8084546, incorporated by reference. If the outer (hard) blocks are sulfonated, upon exposure to water, hydration of the hard domains may result in plasticization of those domains and softening, allowing dispersion or solubility.

The sulfonated copolymer in embodiments is as disclosed in Pat. Publication Nos. US9861941, US8263713, US8445631, US8012539, US8377514, US8377515, US7737224, US8383735, US7919565, US8003733, US8058353, US7981970, US8329827, US8084546, US8383735, US10202494, and US10228168, the relevant portions are incorporated herein by reference.

In embodiments, the sulfonated block copolymer has a general configuration A-B-(B-A)₁₋₅, wherein each A is a non-elastomeric sulfonated monovinyl arene polymer block and each B is a substantially saturated elastomeric alpha-olefin polymer block, said block copolymer being sulfonated to an extent sufficient to provide at least 1% by weight of sulfur in the total polymer and up to one sulfonated constituent for each monovinyl arene unit. The sulfonated polymer can be used in the form of their acid, alkali metal salt, ammonium salt or amine salt.

In embodiments, the sulfonated block copolymer is a sulfonated polystyrene-polyisoprene-polystyrene, sulfonated in the center segment. In embodiments, the sulfonated block copolymer is a sulfonated t-butylstyrene / isoprene random copolymer with C═C sites in their backbone. In embodiments, the sulfonated polymer is a sulfonated SBR (styrene butadiene rubber) as disclosed in US 6,110,616 incorporated by reference. In embodiments, the sulfonated polymer is a water dispersible BAB triblock, with B being a hydrophobic block such as alkyl or (if it is sulfonated, it becomes hydrophilic) poly(t-butyl styrene) and A being a hydrophilic block such as sulfonated poly(vinyl toluene) as disclosed in US 4,505,827 incorporated by reference. In embodiments, the sulfonated block copolymer is a functionalized, selectively hydrogenated block copolymer having at least one alkenyl arene polymer block A and at least one substantially completely, hydrogenated conjugated diene polymer block B, with substantially all of the sulfonic functional groups grafted to alkenyl arene polymer block A (as disclosed in US 5516831, incorporated by reference). In embodiments, the sulfonated polymer is a watersoluble polymer, a sulfonated diblock polymer of t-butyl styrene / styrene, or a sulfonated triblock polymer of t-butyl styrene -styrene - t-butyl styrene as disclosed in US 4,492,785 incorporated by reference. In embodiments, the sulfonated block copolymer is a partially hydrogenated block copolymer.

In embodiments, the sulfonated polymer is a midblock-sulfonated triblock copolymer, or a midblock-sulfonated pentablock copolymer or, e.g., a poly(p-tert-butylstyrene-b-styrenesulfonate -b-p-tert-butylstyrene), or a poly[tert-butylstyrene-b-(ethylene-alt-propylene)-b-(styrenesulfonate)-b-(ethylene-alt-propylene)-b-tert-butylstyrene.

In embodiments, the sulfonated polymer contains > 15 mol %, or > 25 mol %, or > 30 mol %, or > 40 mol %, or > 60 mol % sulfonic acid or sulfonate salt functional groups based on the number of monomer units in the polymer that are available or susceptible for sulfonation, e.g., the styrene monomers.

In embodiments, the sulfonated polymer has an ion exchange capacity of > 0.5 meq/g, or > 0.75 meq/g, or > 1.0 meq/g, or > 1.5 meq/g, or > 2.0 meq/g, or > 2.5 meq/g, or < 5.0 meq/g.

Optional Additives: In embodiments, the sulfonated polymer further contains or can be complexed with, or otherwise form mixtures, compounds, etc. with, antibiotics such as butylparaben and triclosan, e.g., antimicrobial surfactants, lipids, nanoparticles, peptides, antibiotics or antiviral drugs, quaternary ammonium and phosphonium containing polymers, chitosan and other naturally occurring antimicrobial polymers, ion-exchange resins, metallic-based micro and nano-structured materials such as silver, copper, zinc and titanium and their oxides, for enhanced antimicrobial effectiveness.

In embodiments, the sulfonated polymer further comprises additives for decorative or safety effects, e.g., luminescent additives such as phosphorescent and fluorescence that would help or enable the sulfonated polymer layer to illuminate.

In embodiments, the optional additives are optical brighteners additives that illuminate under a special UV or black light tracer, allowing for physical inspections to verify that intended surfaces are coated or have remained intact, offering the intended antimicrobial / self-disinfecting effects.

In embodiments, the optical additives are UV stabilizers, e.g., UV absorbers, quenchers known in the art.

In embodiments, the sulfonated polymer further comprises additives that would help signal or give an indicator of its antimicrobial effects with a color change pH indicator.. Examples include Thymol Blue, Methyl Orange, Bromocresol Green, Methyl Red, Bromothymol Blue, Phenol Red, and Phenol-phthalein. A color change means a change in hue, from a light to a darker color or vice versa. A color indicator may indicate if a recharge, regeneration, or reactivation of the antimicrobial activity of the protective layer is recommended. The color indicator is incorporated in a sufficient amount so that a noticeable change in color hue is observed immediately when there is a change in the effectiveness of the sulfonated polymeric material, e.g., when its surface pH is increased above 2.0 (different pathogens have different pH responses), the change is known right away. In embodiments, the amount of color indicator ranges from 0.1 to 20 wt.% of the amount of sulfonated polymer applied as a protective layer on the frequently-touched surface.

In addition to the above optional components, other additives such as plasticizers, tackifiers, surfactants, film forming additives, dyes, pigments, cross-linkers, UV absorbers, catalysts, highly conjugated particles, sheets, or tubes (e.g. carbon black, graphene, carbon nanotubes), etc. may be incorporated in any combination to the extent that they do not reduce the efficacy of the material.

Properties of Sulfonated Polymer: When applied as a thin protective layer, the sulfonated polymer is characterized as being transparent. Transparency refers to optical clarity, meaning that enough light is transmitted through to allow visualization through the film by an observer. Although some haze or coloration may be presented, such haze or coloration does not substantially interfere with visualization. In embodiments, an antimicrobial sulfonated polymeric layer has a transmission rate of > 90%, or > 91%; or clarity of >99% or >99.5%; or a haze value of < 1.5%, or < 1.25%, or < 1.0%, or < 0.75%. Haze can be measured according to ASTM D-1003. This is in comparison with clear acrylic layers having transmission of 94.5%, haze of 0.1, and clarity of 100%.

In embodiments, the sulfonated polymer is characterized as being sufficiently sulfonated to have an IEC of > 0.5 meq/g, or 1.5 - 3.5 meq/g, or > 1.25 meq/g, or > 2.2 meq/g, or > 2.5 meq/g, or > 4.0 meq/g, or < 4.0 meq/g.

In embodiments, the sulfonated polymer is characterized as having a surface pH of < 3.0, or < 2.5, or < 2.25, or < 2.0, or < 1.80. It is believed that a sufficiently low surface level, as a result of the presence of sulfonic acid functional groups in the protective layer, would have catastrophic effects on microbes that come in contact with the surface.

In embodiments, the sulfonated polymer works effectively in destroying / inactivating at least > 90%, > 95%, > 99%, or > 99.5%, or >99.9% of microbes in < 120 minutes of exposure, or < 30 minutes of exposure, or < 5 minutes of exposure or contact with microbes, including but not limited to MRSA, vancomycin-resistant Enterococcus faecium, X-MulV, PI-3, SARS-CoV-2, carbapenem-resistant Acinetobacter baumannii, and influenza A virus. In embodiments with polymer containing quaternary ammonium group, the material is effective in killing target microbes including Staphylococcus aureus, Escherichia coli, Staphylococcus albus, Escherichia coli, Rhizoctonia solani, and Fusarium oxysporum. The sulfonated polymer remains effective in killing microbes even after 4 hours, or after 12 hours, or at least 24 hours, or for at least 48 hours. In embodiments, the sulfonated polymer remains effective in killing microbes for at least 3 months, or for at least 6 months.

In tests evaluation the long-lasting antiviral properties, film samples of sulfonated penta block copolymer (SPBC) of the structure poly[tert-butylstyrene-b-(ethylene-alt-propylene)-b-(styrene-co-styrene¬sulfonate)-b-(ethylene-alt-propylene)-tert-butylstyrene] with 52% sulfonation were cast out of 1:1 mixture of toluene and 1-propanol. The sulfonated polymer film samples were subjected to abrasion testing of 2200 cycles in the presence of 3 common disinfectants: 1) 70% ethanol, benzalkonium chloride, and quaternary ammonia], and exposure to SARS-CoV-2 virus suspension of concentration 10⁷ pfu/ml. After 2 hours of contact, viable virus was recovered from each sample by washing twice with 500 µl of DMEM tissue culture media containing 10% serum, and measured by serial dilution plaque assay. Gibco Dulbecco’s Modified Eagle Medium (DMEM) is a basal medium for supporting the growth of many different mammalian cells. The results demonstrate that, after abrasion testing representing approximately one year of cleaning (6 disinfectant wipes/day).

Face Mask Applications: The sulfonated polymer can be used to make textile (e.g., fiber, filament, or yarn), or it can be used to coat textile, with the textile to be subsequently made into fabric and the like, in any form such as woven, knit, and non-woven fabric. The sulfonated polymer can also be used to directly coat fabric, which can be subsequently used to construct face masks, or filters for use in face masks. In embodiments, the sulfonated polymer can be used to directly coat ready-to-wear face masks, or filters for use in face masks.

The face masks protected by the sulfonated polymer generally comprises a fastening member for attaching a body portion of the face mask to the user. The body portion includes a filter configured to be place over a mouth and at least part of a nose of the use so that perspiration air is drawn through the body portion. The face mask has a filter which allows air to pass through from ambient to the wearer.

In embodiments, the filter comprises a plurality of stacked layers having the same or substantially equivalent outer dimensions. In embodiments, the face mask is a respirator (e.g., a N95 respirator). In other embodiments, the mask is a face mask, a surgical mask, a filter mask, a mouth mask, or a gas mask. In certain embodiments, the mask is a N95 respirator, a N99 respirator, or even a N100 respirator.

Respirators refer to “air-purifying respirators,” protecting users by filtering particles out of the air as you breathe. These respirators protect only against particles, not gases or vapors. Since airborne biological agents such as bacteria or viruses, are particles, they can be filtered by particulate respirators. In the US, NIOSH or the National Institute for Occupational Safety and Health (NIOSH) sets standards to test and approve respirators, with respirators filtering out at least 95% of airborne particles are given a 95 rating (e.g, N-95 respirators). Those that filter out at least 99% receive a “99” rating. Those that filter at least 99.97% (essentially 100%) receive a “100” rating.

The filter in embodiments comprises an air permeable substrate, e.g., a nonwoven fabric, having the sulfonated polymer as a coating on the surface of the filter toward the wearer. In embodiments, the sulfonated polymer is a coating on the surface of the body portion opposite the surface facing the wearer. Nonwoven is a type of fabric that is bonded together rather than being spun and woven into a cloth. It may be a manufactured sheet, mat, web or batt of directionally or randomly oriented fibers bonded by friction or adhesion. Examples of nonwoven filter media include but are not limited to nylon, polyethylene, polypropylene, polyethylene terephthalate, polyester, etc. or any other polymer suitable for a filter substrate.

The sulfonated polymer may be applied onto the surface of the filter by dissolving the polymer into a suitable solvent and then applying the coating by using methods including but not limited to spray coating, thermal lamination, calendaring or rollers, knife-over-roll coating, adhesive lamination, screen-printing, transfer coating, and gravure coating as disclosed in U.S. Pat. No. 5,597,618, incorporated by reference. The coating is applied onto the filter for a thickness of < 4000 µm, or < 3500 µm, or < 3000 µm, or > 1 µm, or >10 µm, or >20 µm, or 5-3500 µm, or 10-3000 µm, or 100-2500 µm, or 500-2000 µm.

In embodiments, the sulfonated polymer is first electrospun generating nanoscale to microscale fibers having disinfecting properties. The electrospinning process is known, as disclosed in U.S. Pat. Nos. 4,043,331 and 4,878,908, incorporated by reference, which can be used to generate sulfonated microfibers from 100 nanometers to about 250 microns, or 50-150 microns, or 40-90 microns, for use in the protective filter for the face mask. In embodiments, the electrospun sulfonated microfibers are interweaved with fibers from other different polymers, e.g., microfibers, submicron fibers and nanofibers formed from cellulose acetate (CA), polyolefin, polyamide 6 (PA 6), polystyrene (PS), polyacrylonitrile (PAN), polyvinylpyrrolidone (PVP), polyvinyl alcohol (PVA), poly(lactic acid) (PLA), poly(lactic-co-glycolic acid) (PLGA), polybutylene terephthalate (PBT) and polyurethane (PU), or natural polymers such as gelatin, chitosan and polyhydroxybutyrate-co-hydroxyvalerate (PHBV).

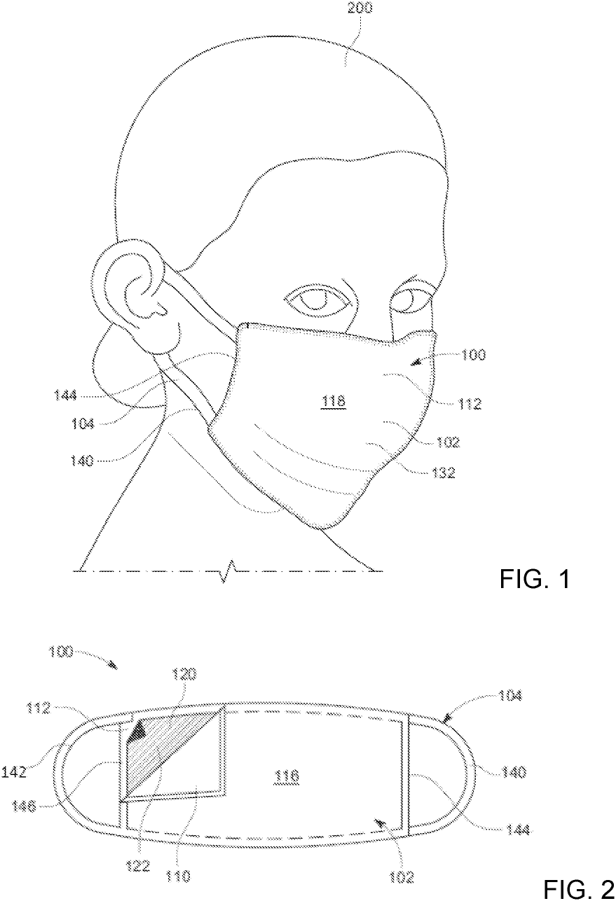

In embodiments, the body portion of the face mask or the mask pad, or the face mask itself functions as the filter (as shown in FIG. 1), e.g., a quick mask constructed out of fabric or in instances, out of heavy-duty paper. In other embodiments, the body portion comprises multiple layers with at least one of the layers functions as a filter (e.g., as shown in the others figures). In embodiments, the filter is composed of multiple layers, e.g., a non-active inner layer made of materials as a supporting layer, a non-active middle layer comprising nonwoven fibers to filter out particulates, and a layer comprising or coated with the sulfonated polymer that rapidly inactivates pathogens. In embodiments, in addition to the protection of the sulfonated polymer, one of the filters may incorporate a catalyst material known in the art to absorb various harmful gases or particulates present in the air.

The material for constructing the different layers can be any suitable fabric, such as, cotton, non-woven poly propylene, or any other suitable material that is air permeable and permits a passage of air therethrough, and may filter the air by restricting the passage of foreign particles, such as, microbes, particulates, etc., having a size greater than a predetermined threshold size. The various layers can be attached to each other by stitching, ultrasonic welding, or any other suitable method known in the art.

When the face mask is worn, virus-laden droplets are rapidly absorbed and killed by the sulfonated polymer. It should be noted that more than one layer with sulfonated polymers can be used, with one facing the wearer for killing virus exhaled by the wearer, and an external layer for killing virus that may come into contact with the face mask.

Reference will be made to the figures, showing various embodiments of the face masks.

FIG. 1 illustrates an embodiment of a simple face mask 100, with a mask pad 102 which also functions as a filter, adapted to be arranged in front of the face of a wearer 200, covering a mouth and a nose, and an engagement structure 104 for attaching the face mask 100 to the wearer 200 such that the mask pad 102 covers the mouth and the nose of the wearer 200. The mask pad 102 may be made of soft fabric and may include a plurality of layers, including layer 112. In embodiments both outer surface 118 (and inner surface facing wearer) are coated or protected with a coating 132 containing the sulfonated polymer. The loops 140 and 142 (not shown) may be secured / connected / supported on the ear lobes of the wearer 200 with engagement structure 104 extending from the side edge 144 of the mask pad.

FIG. 2 illustrates a second embodiment of a face mark 100, with the mask pad 100 having a plurality of air permeable layers with at least a layer functioning as a filter. The mask pad comprises a first layer 110 and a second layer 112 disposed opposite to the first layer 110. Each is engaged / attached to each other along respective edges. Immediate layer 120 can be a removable filter coated with the sulfonated polymer (on one or both sides of filter). The mask pad 102 includes a first surface 116 (i.e. inner surface 116), and a second surface (not shown) disposed opposite to the inner surface 116. The inner surface 116 of the mask pad 102 is adapted to be disposing proximate and facing the face of the wearer 200. Ear loops 140 and 142 extend from side edges 144 and 146 respectively to be secured to the ear lobes of wearer (not shown).

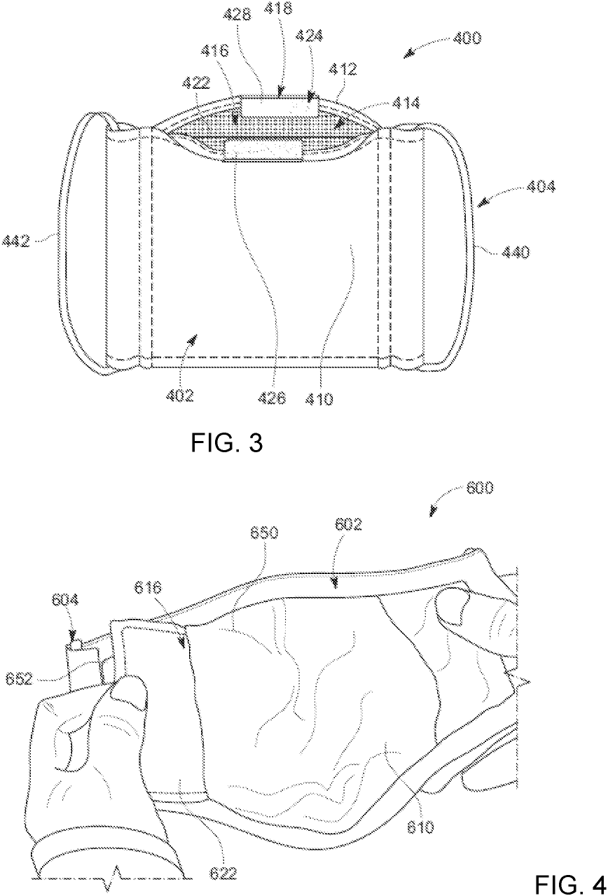

FIG. 3 illustrates a second embodiment of a face mark 400, with a filter 422 being removably disposed between a first layer 410 and a second layer 412 of the face mask 400. The first layer 410 is adapted to arrange facing the face of the wearer 200. The filter 422 may be inserted inside or removed from the chamber 414 through an opening 416 arranged proximate to a top edge of the mask pad 402 and extending substantially parallel to the top edge. The mask pad 402 may include an attachment structure 418, such as a hook and loop fastener assembly 424 with a loop member 426, and a hook member 428 adapted to removably engage with the loop member 426 to temporarily close the opening 416. Engagement structure 404 includes a first loop 440 and a second loop 442 for engaging with the wearer earlobes. In addition to filter 422, layer 410 (facing the wearer) can also be coated with the sulfonated polymer. The outside of layer 412 can also be coated with the sulfonated polymer for killing viruses coming into contact with the face mask.

FIG. 4 illustrates another face mask 600, which includes a mask pad 602, an engagement structure 604, a first layer 610, a second layer (not shown), and a filter 616 which is removable, with at least one of surfaces 622 and 652 being coated with a sulfonated polymer layer, or comprising a sulfonated polymer. The first layer 610 includes a surface 650 which in embodiments is also coated with the sulfonated polymer.

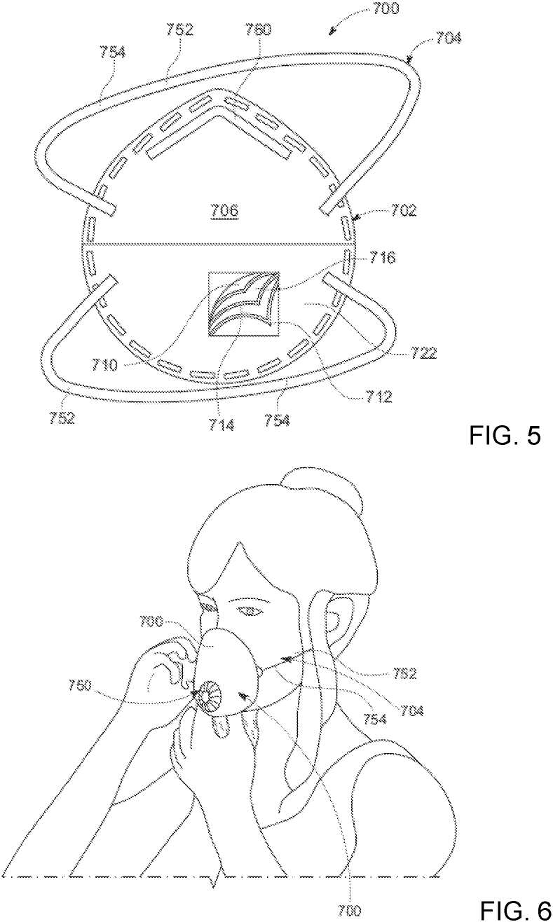

FIG. 5 illustrates an alternative face mask 700, which can be an N95, N90, N99, or any other similar mask adapted to prevent the passage of the particulate matter along with air. The face mask 700 includes a mask pad 706 and an engagement structure 704 to secure the face mask to the wearer. The mask pad 706 has an arcuate shape or a cup shape, with outer surface and inner surface (not shown) defining a cavity and adapted to face the wearer. The mask pad 706 includes a plurality of layers, e.g., a first layer 710 and a second layer 712, and an intermediate layer 714 sandwiched between the first layer 710 and the second layer 712. In embodiments, the intermediate layer 714 is a filter having at least a surface 716 coated with the sulfonated polymer. Filter 714 prevents a passage of particulates along with the air through the mask pad. Engagement structure 704 includes at least loops 752 attached to the mask pad at the side of the face mask 702, with one of the loops being an elastic loop 754. Nose pin 760 is adapted to secure/retain the mask pad 706 on the nose of the wearer.

In FIG. 6, the face mask 700 including a valve 750 to enable an easy exit of air to an ambient exhaled by the wearer. The valve 750 may include a filter pad (not shown) comprising or coated with the sulfonated polymer. Engagement structure 704 includes at least one loop 752 to engage with the head of the wearer 200 to secure/attach the face mask 700 to the wearer. In embodiments, the at least one loop 752 is an elastic loop 754.

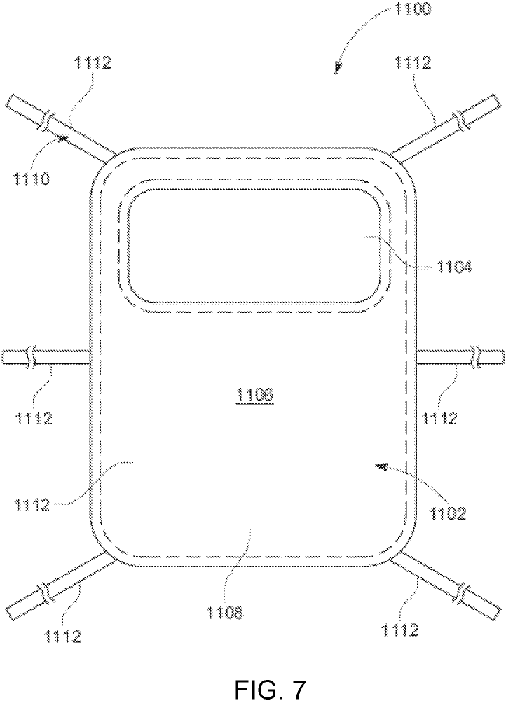

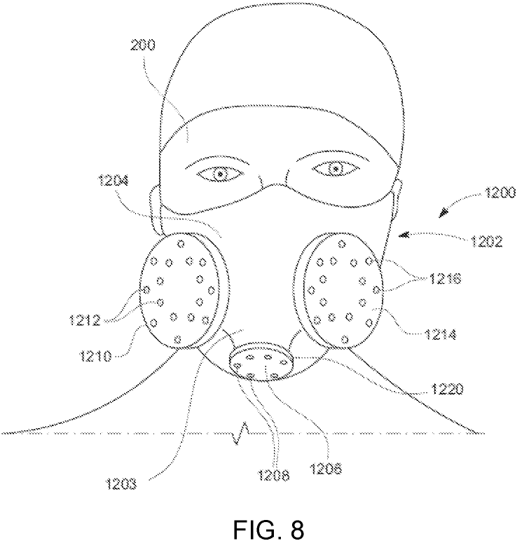

FIG. 7 illustrates an alternative face mask 1100 adapted to cover the eyes along with the nose and the mouth of the wearer (not shown). The mask pad 1102 includes a transparent screen 1104 adapted to be arranged covering the eyes of the wearer to enable a viewing of the ambient. The face mask 1100 includes at least a layer coated with or constructed from the sulfonated polymer, e.g., outer surface 1106 coated with a sulfonated polymer coating 1108 to kill microbes that may contact the outer surface. In embodiments, the inner surface (not shown) facing the wearer and opposite to the outer surface 1106 is coated with the sulfonated polymer. The transparent screen 1104 may also be coated with a sulfonated polymer. The face mask 1100 includes an engagement structure 1110 structure with a plurality of ties 1112, attached to the side edges of the mask pad 1102 to facilitate attachment to the wearer.

FIG. 8 illustrates a face mask 1200, with mask body 1202 adapted to prevent a passage of one or more gases, e.g., chlorine, along with air inhaled by the wearer 200. Gas mask 1202 may include mask pad 1203 having a frame 1204 (coated) adapted to cover the mouth and nose of the wearer 200, inlet member 1206 having at least one inlet port 1208 to facilitate an intake of air and at least one outlet member, e.g., outlet member 1210 having at least one first outlet port 1212 and a second outlet member 1214 having at least one second outlet port 1216, for facilitating a discharge of air exhaled by the wearer 200. Mask body 1202 may be made of a flexible material, such as, a cloth, or any other suitable materials, such as, a plastic, etc. Surface of mask body 1202 in embodiments is coated with the sulfonated polymer. Inlet member 1206 in embodiments include a casing 1220 and at least a removable filter (not shown) disposed inside the casing and adapted absorb one or more gases, for example, a chlorine gas, and coated with or is constructed from sulfonated polymer, configured to kill virus upon contact. In embodiments, filter (not shown) may include absorbent layers for absorbing the one more gases present in the air inhaled by the wearer.

Examples: The following examples are intended to be non-limiting.

Example 1: Tests were conducted to evaluate antimicrobial efficacy & the long-lasting antiviral properties of sulfonated polymers, film samples of sulfonated penta block copolymer (SPBC) of the structure poly[tert-butylstyrene-b-(ethylene-alt-propylene)-b-(styrene-co-styrene¬sulfonate)-b-(ethylene-alt-propylene)-tert-butylstyrene] with 52% sulfonation were cast out of 1:1 mixture of toluene and 1-propanol. The sulfonated polymer film samples were subjected to abrasion testing of 2200 cycles in the presence of 3 common disinfectants: 1) 70% ethanol, benzalkonium chloride, and quaternary ammonia], and exposure to SARS-CoV-2 virus suspension of concentration 10⁷ pfu/ml.

After 2 hours of contact, viable virus was recovered from each sample by washing twice with 500 µl of DMEM tissue culture media containing 10% serum, and measured by serial dilution plaque assay. Gibco Dulbecco’s Modified Eagle Medium (DMEM) is a basal medium for supporting the growth of many different mammalian cells. The results demonstrate that, after abrasion testing representing approximately one year of cleaning (6 disinfectant wipes/day), surface pro Gibco Dulbecco’s Modified Eagle Medium (DMEM) is a widely used basal medium for supporting the growth of many different mammalian cells.

Example 2: Woven fabric of nylon 6, 6 fibers is immersed for 5 minutes in a solution of 0.5 g potassium t-butoxide and 0.5 g methanol in 10 ml of DMSO to provide deprotonated amines on the amide nitrogen in the polymer backbone. The deprotonated polymer is immersed in a solution of 0.33 g of sodium 4-bromobenzylsulfonic acid in 3.3. g DMSO (52° C.) to provide a fabric of polyamide fibers having benzylsulfonate groups attached to the surface thereof. The fabric of sulfonated polyamide fiber is washed with deionized (DI) water and dried to provide a fabric for making into protective face masks.

Example 3: A sulfonated polyester fabric is prepared, for use in making face masks, protective clothing, and the like. First a polyester taffeta made of polyester fiber is put into an acid-resistant sealable container. Sulfuric anhydride previously diluted 10 times with nitrogen gas is brought into contact with the polyester cloth for a sulfonated polyester material. The cloth is then washed with water and dried to produce a sulfonated polyester fabric, which can be used to make into face masks.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A face mask comprising:
a mask body configured to cover at least a wearer’s mouth and nose, the mask body allows passage of air from ambient through to the wearer, the mask body has a first surface facing the face of the wearer and a second surface disposed opposite to the first surface and exposed to the ambient; and
an engagement structure configured to attach the mask body to the wearer’s head;
wherein at least one of the first surface and the second surface is protected by a sulfonated polymeric layer for killing at least 95% microbes within 30 minutes of contact with the first surface; and
wherein the sulfonated polymeric layer consists essentially of a sulfonated polymer, the sulfonated polymer is selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof;
wherein the sulfonated polymer has a degree of sulfonation of at least 10%;
wherein the sulfonated polymeric layer has a thickness of at least > 1 µm.

2. The face mask of claim 1, wherein the mask body has a Bacteria Filtration Efficiency (BFE) of > 60%.

3. The face mask of claim 1, wherein the sulfonated polymer has an ionic exchange capacity (IEC) of > 0.5 meq/g.

4. The face mask of claim 1, wherein the sulfonated polymeric layer has a surface pH of < 3.0.

5. The face mask of claim 1, wherein the sulfonated polymer is neutralized with at least salt selected from ammonium, phosphonium, pyridinium, and sulfonium salts.

6. The face mask of claim 1, wherein the sulfonated polymeric layer has a thickness of at least > 5 µm to kill > 95% of microbes within 120 minutes of contact after six months of protection.

7. The face mask of claim 1, wherein the sulfonated polymer is selectively sulfonated to contain from 10 - 100 mol % sulfonic acid or sulfonate salt functional groups based on the number of monomer units or blocks in the sulfonated polymer susceptible to sulfonation, for the coating material to kill at least 95% of microbes within 30 minutes of contact.

8. The face mask of claim 1, wherein the sulfonated polymer is a selectively sulfonated negative-charged anionic block copolymer having a general configuration of: A-B-A, (A-B)n(A), (A-B-A)n, (A-B-A)ₙX, (A-B)nX, A-D-B, A-B-D, A-D-B-D-A, A-B-D-B-A, (A-D-B)ₙA, (A-B-D)ₙA (A-D-B)ₙX, (A-B-D)ₙX or mixtures thereof, wherein
n is an integer from 0 to 30,
X is a coupling agent residue,
each A and D block is a polymer block resistant to sulfonation,
each B block is susceptible to sulfonation,
the A block is selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof;
the B block is a vinyl aromatic monomer, and
the D block is a hydrogenated polymer or copolymer of a conjugated diene selected from isoprene, 1,3-butadiene and mixtures thereof; and
wherein the block B is selectively sulfonated to contain from 10 - 100 mol % sulfonic acid or sulfonate salt functional groups based on the number of monomer units, for the coating material to kill at least 99% of microbes within 30 minutes of contact.

9. The face mask of claim 1, wherein the mask body includes a filter for filtering air passing therethrough, wherein the filter also comprises a sulfonated polymeric layer.

10. The face mask of claim 9, wherein the filter is removable from the mask body.

11. The face mask of any of claim 1, further including an engagement structure for engaging the face mask to the wearer and retaining the mask body covering the mouth and face of the wearer.

12. The face mask of of claim 1, wherein the face mask is a gas mask and the mask body includes a filter adapted to absorb one or more gases from the air passing therethrough, wherein the filter includes the polymeric layer.

13. The face mask of claim 1, wherein the face mask includes a transparent screen adapted to be arranged covering eyes of the wearer .

14. The face mask of claims 1, wherein the sulfonated polymeric layer is applied onto the first surface by any of coating, lamination, spraying, dispersion coating, or casting.

15. The face mask of of claim 1, wherein the sulfonated polymeric layer has an ion exchange capacity > 1 meq/g .

16. The face mask of claim 13, wherein the transparent screen is coated with a sulfonated polymeric layer, sulfonated to > 25 mol % and configured to kill at least 90% microbes within 30 minutes of contact.

17. The face mask of claim 1, wherein the sulfonated polymeric layer has a surface pH of < 2.5.
